(19) United States
(12) Patent Application Publication
(10) Pub. No.: US 2012/0262269 A1
(43) Pub. Date: Oct. 18, 2012

(54) METHOD FOR MONITORING A SPACE ACCESSIBLE THROUGH A CONTROL DOOR AND CONTROL DOOR

(76) Inventor: Jacques Barsi, Chennevieres Sur Marne (FR)

(21) Appl. No.: 12/452,661

(22) PCT Filed: Jul. 22, 2008
(86) PCT No.: PCT/FR2008/051376

§ 371 Date: May 21, 2012

(30) Foreign Application Priority Data
Jul. 23, 2007 (FR) 0756682

(51) Int. Cl. G06F 7/04; E06B 7/00; E06B 5/00

(52) U.S. Cl. 340/5.7; 49/70; 49/13

(57) ABSTRACT

The invention relates to a method for monitoring a space that can be accessed through a control door (1), said method being characterised in that it comprises: i) monitoring the opening of the door (1); ii) as soon as a minimal opening of the door (1) occurs, powering a first monitoring means (2) and a second monitoring means of a first monitoring area (4) and a second monitoring area (5), and carrying out the following steps in a continuous and simultaneous manner up to the closing of said control door (1): determining if one or no or several persons have crossed the first monitoring area (4); determining if the second monitoring area (5) has been crossed; iii) taking into account this information for determining if the passage is compliant and unitary. The invention also relates to a control door for implementing said method.

This invention concerns the area of building security, in particular single passage control, and its object is a method for monitoring a space accessible by a control door as well as such a control door.

Certain buildings, such as banks, airports and military installations, require secure access that permits guaranteeing single passage of a person in order to prevent any passage of an unauthorized person.

The control doors of this type that are used today permit correctly satisfying the usual requirements, i.e., detecting the presence of one or several persons. However, they present a major drawback inherent in the single passage control system associated with these doors.

In fact, because the monitoring is realized through emitting infrared cells, the latter must be located in a secure location. Because of this, these cells cannot be integrated outside of the zone to be secured (for example, outside the building) because this exposes them to an excessive risk of vandalism or attempted destruction.

In addition, said cells must be arranged on the side opposite the door opening so as not to be blinded by the latter; in other words, such that the door does not create an obstacle to the rays emitted or received by said cells.

These two conditions impose restrictions on the installation of a device for determining single passage.

US-A-2002/176607 proposed a single passage control door providing access to a space including a first and second monitoring means connected to a managing means, said monitoring means being invisible when the control door is in the closed position. Still, these monitoring means are neither invisible nor inaccessible when the door is in the closed position. In fact, these monitoring means are arranged in the ceiling and are thus necessarily accessible, at least from the interior of the building in which the door is integrated. In addition, this document does not anticipate that these means are not visible when the door is closed.

In addition, one is aware, through FR-A-2 596 900, of a method for monitoring a space accessible through a control door. However, it does not permit single passage control in said space.

The purpose of this invention is to remedy these drawbacks by enabling reliable and tamper-proof single passage control.

For this purpose, its object is a method for monitoring a space accessible through a control door. This method is designed to perform single passage control in said space, consisting of
i) monitoring the opening of the control door,
ii) upon minimal opening of the control door, corresponding to a possibility of passage for a single person, powering a first monitoring means of a first monitoring zone and a second monitoring means of a second monitoring zone, and carrying out the following steps in a continuous and simultaneous manner until the closing of said control door:
   determining, through the first monitoring means, if one or no or several persons have crossed the first monitoring zone,
   determining, through the second monitoring means, if the second monitoring zone, which is monitored by the latter, has been crossed,
iii) taking into account this information to determine if the passage is compliant and unitary,
method characterized in that it consists of monitoring the first monitoring zone and the second monitoring zone located in the volume delimited by the door frame of the control door, the first monitoring zone presenting a limited width across which a person must pass and the second monitoring zone constituting an additional zone not to be crossed, and in that it consists of considering any shadowing in the second monitoring zone as noncompliant passage.

The invention also has the object of a single passage control door providing access to a space including a first and second monitoring means connected to a means for implementing the method, characterized in that the said first and second monitoring means are invisible when the control door is in the closed position.

The invention will be better understood through the following description, which relates to preferred embodiments, offered as non-restrictive examples, and explained with reference to the attached schematic drawings, in which:

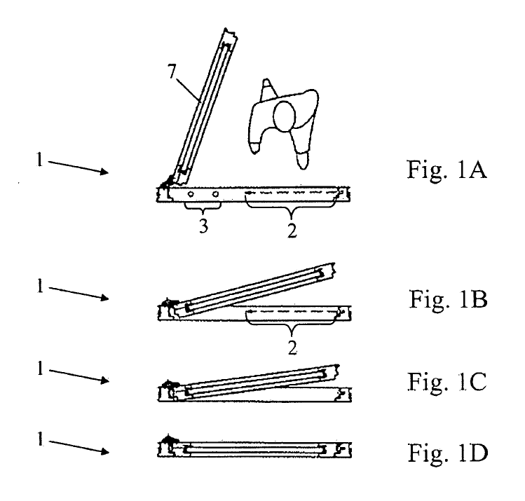

FIGS. 1A to 1D represent a view from above a single passage control door according to a first embodiment of the invention, in different positions;

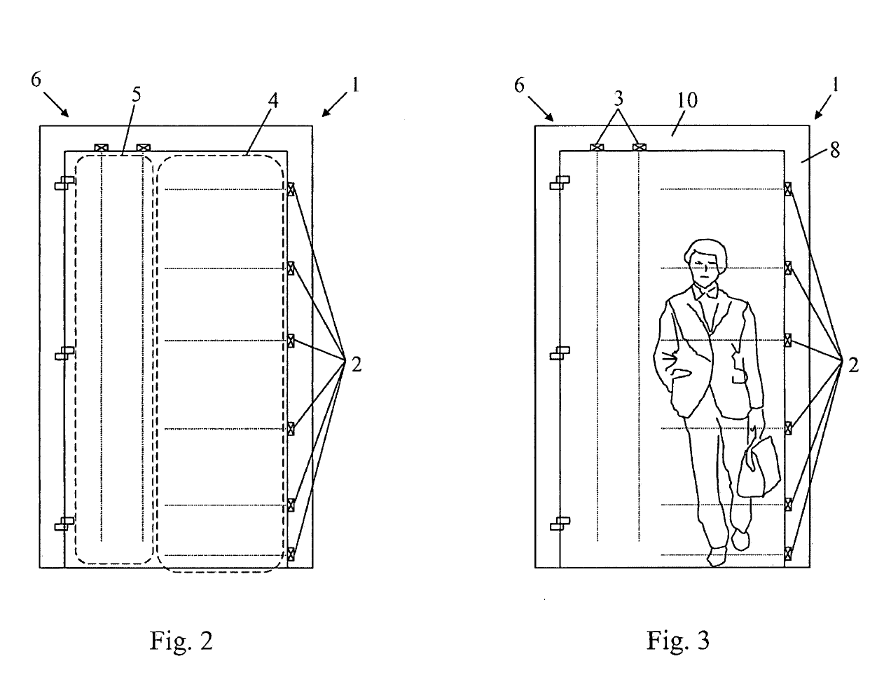

FIG. 2 represents a side elevation view of the control door represented in FIGS. 1A to 1D;

FIG. 3 is a view similar to that of FIG. 2 representing the compliant passage of one person;

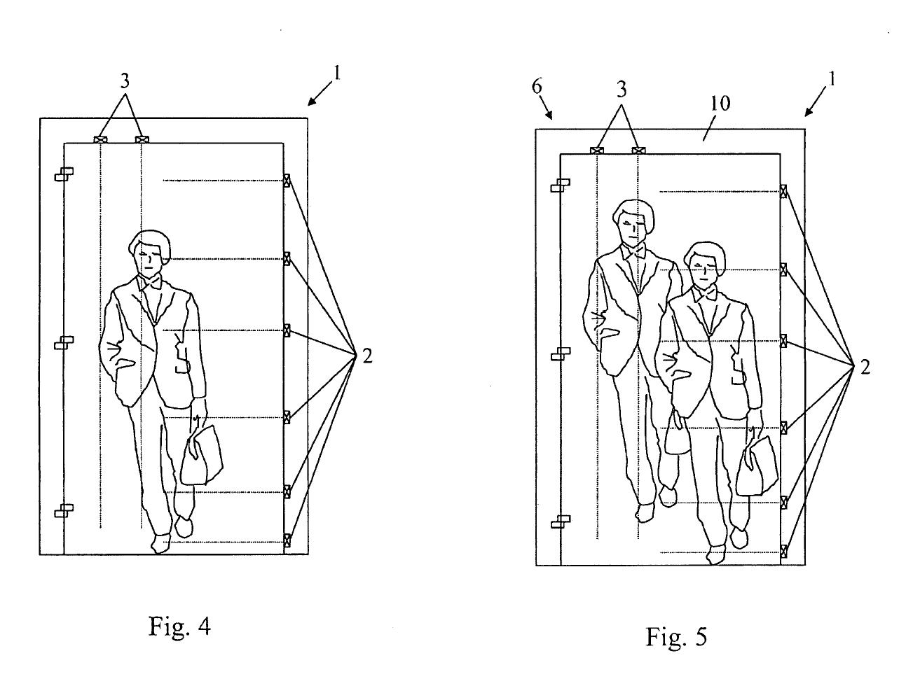

FIG. 4 is a view similar to that of FIG. 2 representing the noncompliant passage of one person,

FIG. 5 is a view similar to that of FIG. 2 representing the noncompliant passage of two persons,

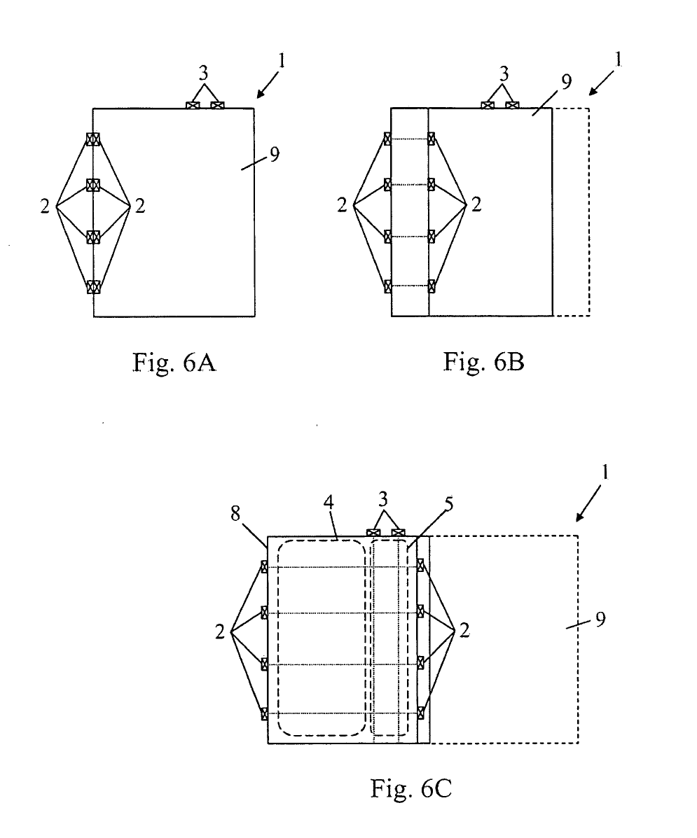

FIGS. 6A to 6C are simplified representations in side elevation of a single passage control door according to the second embodiment of the invention in different positions, namely, respectively, a closed position, an intermediate open position, a second open position, and then a position of almost complete opening of the control door for the passage of one person, and

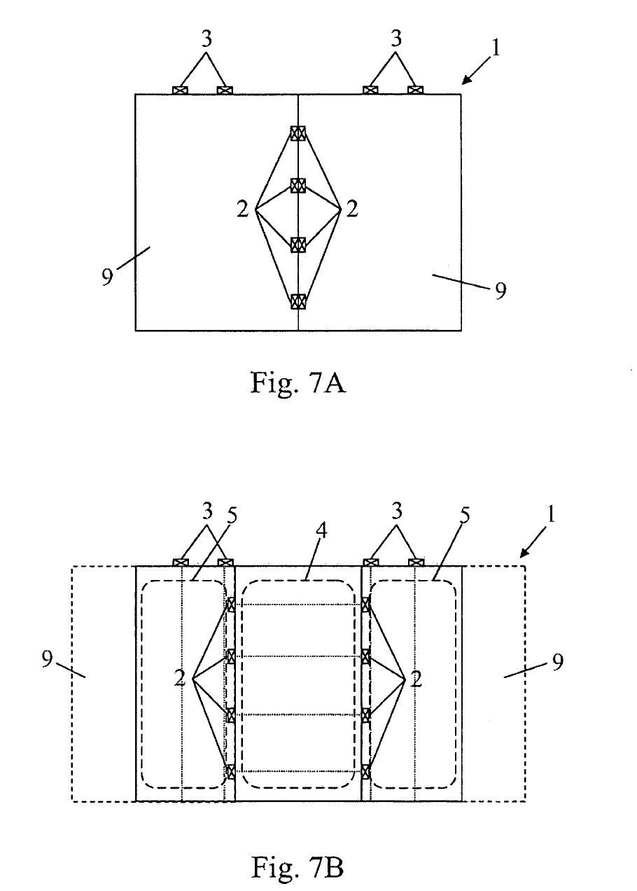

FIGS. 7A and 7B are side elevation views of a single passage control door according to the third embodiment of the invention in a closed position and an intermediate open position.

The method for monitoring a space accessible through a control door 1 according to the invention is designed to perform single passage control in said space. For this purpose, this method for monitoring is intended to perform single passage control in said space and consists of:
i) monitoring the opening of the control door 1,
ii) upon minimal opening of the control door 1, corresponding to a possibility of passage for a single person, powering a first monitoring means 2, 20, 200 of a first monitoring zone 4 and a second monitoring means 3, 30, 300 of a second monitoring zone 5, and carrying out the following steps in a continuous and simultaneous manner until the closing of said control door 1:
   determining, through the first monitoring means 2, 20, 200, if one or no or several persons have crossed the first monitoring zone 4,
   determining, through the second monitoring means 3, 30, 300, if the second monitoring zone 5, which is monitored by the latter, has been crossed,
iii) taking into account this information to determine if the passage is compliant and unitary.

In accordance with the invention, this method consists of monitoring the first monitoring zone 4 and the second monitoring zone 5 located in the volume delimited by the door frame 6 of the control door 1, the first monitoring zone 4 presenting a limited width across which a person must pass and the second monitoring zone 5 constituting an additional zone not to be crossed, and of considering any shadowing in the second monitoring zone 5 as noncompliant passage.

The considering of information from the first and second monitoring means 2, 20, 200; 3, 30, 300 consists of determining, using this information, possibly correlated with other data, if one or no or several persons have entered the space.

According to the invention, the first monitoring means 2, 20, 200 may consist, in addition, of determining the number of persons having crossed the first monitoring zone 4.

The first and second monitoring zones 4 and 5 are represented more specifically in FIG. 2, in the case of a control door 1 including a door leaf. The first monitoring zone 4 of limited width corresponds to the zone that must be crossed by the person desiring access to the space monitored. It must be sufficiently wide for an individual to be able to cross it, but also sufficiently narrow to prevent the passage of two individuals side by side. As for the second monitoring zone 5, the latter corresponds to the zone remaining in the passage of the control door 1. When this zone is crossed, the method may anticipate the issuance of an error signal indicating that the passage is not compliant and an invitation to begin said passage again.

In a characteristic manner, the method may consist of considering as compliant passage any shadowing occurring only in the first monitoring zone 4. Thus, to carry out a compliant and unitary passage, it is necessary that only one person cross the first zone 4.

In the event of a compliant passage, the method may consist of analyzing the shadowing of the first monitoring zone 4 and correlating it with other parameters to determine if the passage is unitary. Other data or parameters that may be taken into account could be temporal data. For this purpose, it is possible to consider taking into account the time of opening of the control door 1 or the length of time during which shadowing occurs in the first monitoring zone 4.

The method according to the invention is particularly intended to be integrated in buildings or departments in which it is necessary, on one hand, to guarantee the security of the first person who, arriving in the morning, unlocks the security system, and on the other hand, to permit access to the public.

For this purpose, this method may consist of monitoring a space forming an airlock and culminating in an exit door to a secured perimeter, by authorizing, after closing of the control door 1, and if single passage has been verified, access to the secured perimeter by the exit door.

This method permits preventing access to the security perimeter when more than one person is present in the airlock. This may be performed as follows: for example, the person authorized to penetrate the secured perimeter unlocks the control door 1. The control door 1 being unlocked, a malefactor pushes the first person into the airlock and enters it also. Given that the first and second monitoring means 2, 20, 200; 3, 30, 300 are powered based on a certain opening of the control door 1, they detect any shadowing occurring in the first and second monitoring zones 4 and 5 located in the volume delimited by the door frame 6 of the said control door 1, such that it is determined whether anyone has stepped over the control door 1 and, if applicable, whether one or more persons were involved. In the event that several persons are in the airlock, this is considered to be fraudulent and the exit door is not unlocked.

If no fraud is detected, it may be anticipated to ask the person present in the airlock to confirm his or her identity by any appropriate means, such as by voice recognition, retinal optical verification, etc., before the opening of the exit door providing access to the secured perimeter to this one person.

In general, it may be anticipated that this process is not started or scheduled until after the closing of the protected buildings or departments. It may be planned that after entry to the secured perimeter, the method is triggered to permit normal access to the secured building or perimeter in question.

The invention also has the object of a single passage control door 1 providing access to a space including a first monitoring means 2, 20, 200 and second monitoring means 3, 30, 300 connected to a means for managing the implementation of the method described above. This control door 1, represented according to several embodiments in the attached figures, is characterized in that the said first and second monitoring means 2, 20, 200; 3, 30, 300 are invisible when the said control door 1 is in the closed position.

Under these conditions, the inviolable nature of the control door 1 is improved and it is impossible to obscure a monitoring means to try to breach the secured perimeter, given that all of these means 2, 20, 200 and 3, 30, 300 are neither visible nor accessible.

According to the first embodiment, represented in FIGS. 1A, 1B, 1C, 1D and 2 to 5, the control door 1 may consist of a single door leaf 7 and be equipped with a first monitoring means 2 of the first zone 4, of limited width, across which must pass one person, and of a second monitoring means 3 of the additional second zone 5 which is not to be crossed, said first and second monitoring means 2 and 3 being integrated in the door frame 6 of said control door 1, in the plane of the door leaf 7 when the latter is in the closed position.

Because the first and second monitoring means 2 and 3 are integrated in the door frame 6 of the control door 1, and in particular in the plane of the door leaf 7, they are protected when the control door 1 is closed.

In addition, security is guaranteed because any opening of the control door 1 wide enough to allow a person to pass leads to the powering of the first and second monitoring means 2 and 3. As a result, any passage is automatically detected by the latter means and is taken into account by the managing means.

In a characteristic manner, the first monitoring means 2 of the first zone 4 of limited width can consist of emitting/receiving cells over a determined distance, integrated in the vertical jamb 8 located next to the opening of said control door 1, namely the side opposite the articulated side on the vertical jamb corresponding to the door frame 6 and the second monitoring means 3 of the additional second zone 5 may consist of at least one emitting/receiving cell integrated in the horizontal top rail 10 of the door frame 6 of said control door 1 located next to the articulated side on the vertical jamb corresponding to the door frame.

FIGS. 1A to 1D represent an example of embodiment of such a control door 1. A magnetic contact may be anticipated to permit the managing means to be alerted of the opening of the control door 1 and, if applicable, initiate timing. FIG. 1A represents the control door 1 in a closed state in which the first and second monitoring means 2 and 3 are not powered. The latter are not powered until a determined opening of the door leaf 7 is reached, permitting the passage of one individual, here an angle of 15°. Before this angle of opening is reached, the cells of the first and second monitoring means 2 and 3 are obscured by the door leaf 7 of the control door 1. As soon as this angle is reached, the cells of the first and second monitoring means 2 and 3 are no longer obscured by the door leaf 7 of the control door 1 and are thus ready to detect any passage.

FIGS. 3, 4 and 5 represent the typical cases occurring in the event of single passage control of such a control door 1. FIG. 3 represents an individual crossing only the first monitoring zone 4. This passage will be considered unitary by the managing device that may control, for example, the opening of an exit door leading to a secured perimeter.

As for the individual represented in FIG. 4, he is crossing at the same time the first and second monitoring zones 4 and 5. Under these conditions, the managing device considers the passage to be noncompliant.

The same is true for the situation with two individuals represented in FIG. 5. The managing means will receive, on one hand, information relative to the shadowing of the second monitoring zone 5 which will result in noncompliance of passage and, on the other hand, the analysis of the shadowing of the first monitoring zone 4, correlated with other parameters enabling it to conclude that the passage is also not unitary.

For example, the analysis of the shadowing of the first monitoring zone 4 may consist of counting the number of shadowings occurring at the level of the cells located in the lower part of the vertical jamb 8, these shadowings corresponding to the passage of an individual's legs.

Advantageously, the first monitoring means 2 of the first zone 4 of limited width may consist of infrared emitting/receiving cells with background suppression.

According to a second embodiment represented in FIGS. 6A to 6C, the control door 1 may consist of a sliding panel 9 and be equipped with a first monitoring means 20 and a second monitoring means 30, the first monitoring means 20 consisting of two facing rows of cells, the first row consisting of receiving cells and the second row consisting of emitting cells, said rows being integrated in the vertical jamb 8 of the control door 1 located next to the opening of the sliding panel and in the face of the sliding panel located opposite said vertical jamb 8, or inversely, and the second monitoring means 30 consisting of at least one emitting/receiving cell integrated in the zone of the horizontal rail 10 of the door frame 6 located opposite the vertical jamb 8 in which is integrated a row of cells at the level of the recess of the control door 1.

In this embodiment, the first and second monitoring means 20 and 30 are also not visible, not accessible and thus protected when the control door 1 is closed. FIG. 6A represents for this purpose such a control door 1 in a closed position. The first monitoring means 20, consisting of cells arranged in the side of the sliding door 9 and in the vertical jamb 8 facing the latter, is completely protected when the control door 1 is closed: said cells are positioned against each other.

Security is also guaranteed because any opening of the control door 1 wide enough to allow a person to pass leads to this person being automatically detected by the cells of the first monitoring means 20 (see FIG. 6B).

It may be planned that the cells forming the second monitoring means 30 are not powered at the same time as the cells forming the first monitoring means 20, but only after opening of the sliding panel 9 beyond the position of said cells forming the first monitoring means 20. If an individual crosses the second monitoring zone 50, the corresponding passage is considered noncompliant.

In the third embodiment of the invention represented in FIGS. 7A and 7B, the control door 1 may consist of two sliding panels 9 and be equipped with a first monitoring means 200 and a second monitoring means 300, the first monitoring means 200 consisting of two facing rows of cells, the first row consisting of receiving cells and the second row consisting of emitting cells, said rows being integrated in the lateral faces of the two sliding panels 9 facing each other and the second monitoring means 300 consisting of at least two emitting/receiving cells integrated in the horizontal rail 10 of the door frame 6, on either side of the central zone of said horizontal rail 10.

FIG. 7B represents this central zone corresponding to the first monitoring zone 4 that must be crossed to obtain compliant passage. In this embodiment, the second monitoring zone 5 consists of two monitoring zones, located on either side of the first monitoring zone 4 and which must not be crossed in order to obtain compliant passage. The cells may be powered in the same way as described in relation to the second embodiment in which the control door 1 includes a single sliding panel 9.

Advantageously, the invention anticipates that the cells forming the first and second monitoring means 2, 20, 200; 3, 30, 300 can be infrared or ultrasound cells, regardless of the embodiment.

Thanks to the invention, it is thus possible to establish a reliable and inviolable level of security in which, on one hand, the active means 2, 20, 200; 3, 30, 300 determining opening and access to a secured zone are neither visible nor accessible when the control door 1 is closed and, on the other hand, permitting determining with certainty that the conditions of compliant and unitary passage are met.

Of course, the invention is not limited to the embodiment described and pictured in the attached drawings. Modifications are still possible, including from the point of view of constitution of the various elements or by substitution of technical equivalents, without going outside the field of protection of the invention.

1. Method for monitoring a space accessible through a control door (1), designed to perform single passage control in said space, consisting of
i) monitoring the opening of the control door (1),
ii) upon minimal opening of the control door (1), corresponding to a possibility of passage for a single person, powering a first monitoring means (2, 20, 200) of a first monitoring zone (4) and a second monitoring means (3, 30, 300) of a second monitoring zone (5), and carrying out the following steps in a continuous and simultaneous manner until the closing of said control door (1):
determining, through the first monitoring means (2, 20, 200), if one, some or several persons have crossed the first monitoring zone (4),
determining, through the second monitoring means (3, 30, 300), if the second monitoring zone (5), which is monitored by the latter, has been crossed,
iii) taking into account this information to determine if the passage is compliant and unitary,
method characterized in that it consists of monitoring the first monitoring zone (4) and the second monitoring zone (5) located in the volume delimited by the door frame (6) of the control door (1), the first monitoring zone (4) presenting a limited width across which a person must pass and the second monitoring zone (5) constituting an additional zone not to be crossed, and in that it consists of considering any shadowing in the second monitoring zone (5) as noncompliant passage.

2. Method, according to claim 1, characterized in that the first monitoring means (2, 20, 200) may consist, in addition, of determining the number of persons having crossed the first monitoring zone (4).

3. Method according to claim 1 either of claims 1 and 2, characterized in that it consists of considering as compliant passage any shadowing occurring only in the first monitoring zone (4).

4. Method according to claim 3, characterized in that it consists, in the case of a compliant passage, of analyzing the shadowing of the first monitoring zone (4) and correlating it with other parameters to determine if the passage is unitary.

5. Method according to claim 1, consisting of monitoring a space forming an airlock and culminating in an exit door to a secured perimeter, characterized in that it consists of authorizing, after closing of the control door (1), and if single passage has been verified, access to the secured perimeter by the exit door.

6. A single passage control door providing access to a space including a first (2, 20, 200) and second monitoring means (3, 30, 300) connected to a managing means for implementation of the method according to claim 1, characterized in that the said first and second monitoring means (2, 20, 200; 3, 30, 300) are not accessible and not visible when said control door (1) is in the closed position.

7. The door, according to claim 6, characterized in that it consists of a single door leaf (7) and is equipped with a first monitoring means (2) of the first zone (4), of limited width, across which must pass one person, and of a second monitoring means (3) of the additional second zone (5) which is not to be crossed, said first and second monitoring means (2 and 3) being integrated in the door frame (5) of said control door (1), in the plane of the door leaf (7) when the latter is in the closed position.

8. The door, according to claim 7, characterized in that the first monitoring means (2) of the first zone (4) of limited width consists of emitting/receiving cells over a determined distance, integrated in the vertical jamb (8) located next to the opening of said control door (1), namely the side opposite the articulated side on the vertical jamb corresponding to the door frame (5) and in that the second monitoring means (3) of the additional second zone (5) consists of at least one emitting/receiving cell integrated in the horizontal top rail (6) of the door frame (5) of said control door (1) located next to the articulated side on the vertical jamb corresponding to the door frame.

9. The door, according to claim 7, characterized in that the first monitoring means (2) of the first zone (4) of limited width may consist of infrared emitting/receiving cells with background suppression.

10. The door, according to claim 6, characterized in that it consists of a sliding panel and in that it is equipped with a first monitoring means (20) and a second monitoring means (30), the first monitoring means (20) consisting of two facing rows of cells, the first row consisting of receiving cells and the second row consisting of emitting cells, said rows being integrated in the vertical jamb (8) of the control door (1) located next to the opening of the sliding panel and in the face of the sliding panel located opposite said vertical jamb (8), or inversely, and the second monitoring means (4) consisting of at least one emitting/receiving cell integrated in the zone of the horizontal rail (6) of the door frame (5) located opposite the vertical jamb (8) in which is integrated the first monitoring means (20) at the level of the recess of the control door (1).

11. The door, according to claim 6, characterized in that it consists of two sliding panels (9) and in that it is equipped with a first monitoring means (200) and a second monitoring means (300), the first monitoring means (200) consisting of two facing rows of cells, the first row consisting of receiving cells and the second row consisting of emitting cells, said rows being integrated in the lateral faces of the two sliding panels (9) facing each other and the second monitoring means (300) consisting of at least two emitting/receiving cells integrated in the horizontal rail (10) of the door frame (6), on either side of the central zone of said horizontal rail (10).

12. The door, according to claim 6, characterized in that the cells forming the first and second monitoring means (2, 20, 200; 3, 30, 300) can be infrared or ultrasound cells.
